(19) United States
(12) Patent Application Publication
(10) Pub. No.: US 2020/0208274 A1
(43) Pub. Date: Jul. 2, 2020

(54) ENERGY CONVERTING DEVICE FOR CONVERTING ELECTRIC ENERGY INTO CHEMICAL ENERGY, ELECTRICAL NETWORK COMPRISING SUCH AN ENERGY CONVERTING DEVICE, AND METHOD FOR OPERATING SUCH AN ENERGY CONVERTING DEVICE

(71) Applicant: MTU FRIEDRICHSHAFEN GMBH, Friedrichshafen (DE)

(72) Inventors: Philippe GORSE, Friedrichshafen (DE); Wolfgang FIMML, Maurach am Achensee (AT); Manuel BOOG, Aulendorf (DE); Frank GRAF, Karlsruhe (DE)

(21) Appl. No.: 16/616,699

(22) PCT Filed: Jun. 19, 2018
(86) PCT No.: PCT/EP2018/066297

§ 371 Date: Nov. 25, 2019

(30) Foreign Application Priority Data
Jun. 20, 2017 (DE) 10 2017 210 324.8

(51) Int. Cl. C25B 1/04; C10G 2/00; C10L 3/08; C01B 3/04; F02M 25/12

(52) U.S. Cl. CPC C25B 1/04; C10G 2/50; F02M 25/12; C01B 3/042; C10L 3/08

(57) ABSTRACT

An energy converting device and method for converting electric energy into chemical energy, including an electrolysis device which can be connected to an electrical network and is designed to split water into hydrogen and oxygen using electric power; a fuel synthesis device which is fluidically connected to the electrolysis device such that the fuel synthesis device can be supplied with hydrogen generated in the electrolysis device as a reactant, wherein the fuel synthesis device is designed to synthesize a fuel from hydrogen and carbon dioxide; and an internal combustion engine which is fluidically connected to the electrolysis device such that the internal combustion engine can be supplied with oxygen generated in the electrolysis device. The internal combustion engine is designed to be operated in a continuous mode using the oxygen generated in the electrolysis device as combustion gas.

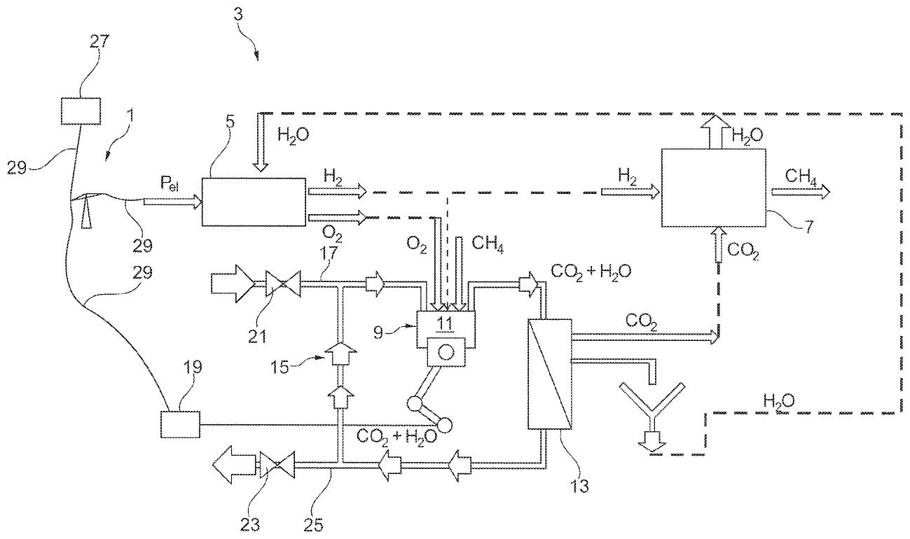

The invention relates to an energy-converting device for converting electrical energy into chemical energy, to an electricity network having an energy-converting device of said type, and to a method for operating an energy-converting device of said type.

Owing to the increasing proportion of regenerative energy sources in electricity networks, the demand for positive and negative control energy, on the one hand, and means for storing energy, on the other hand, is increasing. One expedient possibility for storing energy in the case of excess capacities present in the electricity network is the conversion of electrical energy into chemical energy, for example through the production of methane, which can be stored or fed into an interconnected natural gas network and, at a later point in time, can in turn be converted—in particular by combustion—into other energy forms. It is furthermore known for in particular positive control energy to be provided by means of small or mini power plants, which have at least one combustion engine. Such combustion engines may also be utilized in the context of combined heat and power plants for the purposes of generating electrical power and/or heat. A problem is posed here by the pollutant emissions of such combustion engines, firstly in the form of the climate-relevant gas carbon dioxide and secondly in the form of toxic nitrogen oxides. There is furthermore a demand for more closely integrated utilization of the various concepts, wherein no or only minor synergistic effects have hitherto been achievable in particular between existing synthesis devices for generating chemical substances, on the one hand, and combustion engines utilized for providing positive control energy, on the other hand.

The invention is based on the object of creating an energy-converting device, an electricity network having an energy-converting device of said type, and a method for operating an energy-converting device of said type, wherein the stated disadvantages do not arise.

The object is achieved through the creation of the subjects of the independent claims. Advantageous embodiments emerge from the subclaims.

The object is achieved in particular through the creation of an energy-converting device for converting electrical energy into chemical energy, which energy-converting device has an electrolysis device which is connectable to an electricity network. The electrolysis device is configured to split water into hydrogen and oxygen by means of electrical energy taken from the electricity network. The energy-converting device furthermore has a fuel synthesis device which is connected in terms of flow to the electrolysis device such that hydrogen produced in the electrolysis device can be fed as starting product to the fuel synthesis device, wherein the fuel synthesis device is configured to synthesize a fuel from hydrogen and carbon dioxide. The energy-converting device furthermore has a combustion engine which is connected in terms of flow to the electrolysis device such that oxygen produced in the electrolysis device can be fed to the combustion engine, wherein the combustion engine is configured to be operated in a continuous operation mode with the oxygen produced in the electrolysis device—in particular instead of combustion air—as combustion gas. This yields close interaction and synergy between the combustion engine, on the one hand, and the electrolysis device, on the other hand, because the oxygen that is produced in the electrolysis device and which is not required by the fuel synthesis device can be used in the combustion engine for carrying out a combustion, and in particular as a reaction partner for a fuel with which the combustion engine is operated. At the same time, nitrogen oxide emissions of the combustion engine can be reduced or even avoided entirely if the combustion engine is operated with an oxygen fraction that is increased by means of the oxygen produced in the electrolysis device, or even with pure oxygen from the electrolysis device as combustion gas.

It is particularly preferable if, in the continuous operation mode, the combustion engine is operated in a manner isolated from the ambient air present in its surroundings. In particular, only oxygen, and in particular pure oxygen produced in the electrolysis device, is utilized as the sole combustion gas instead of combustion air. In particular, in the continuous operation mode, no nitrogen is fed to the combustion engine. In particular, nitrogen oxide emissions can be avoided in this way.

Here, the expression “combustion gas” is to be understood to mean a gas or gas mixture which is fed to a combustion chamber of the combustion engine for the conversion of a fuel, in particular for the combustion of the fuel, wherein the combustion gas has at least one reaction partner for the fuel and possibly further gases. Combustion air, in particular ambient air of the combustion engine, is accordingly one particular combustion gas. Pure oxygen is a combustion gas which has exclusively the reaction partner for the fuel that is to be burned in the combustion chamber of the combustion engine, specifically oxygen.

The combustion engine is preferably configured to be operated with a combustion gas/fuel ratio, also referred to as lambda value, of 1. The combustion gas, on the one hand, and the fuel, on the other hand, are thus fed to a combustion chamber of the combustion engine preferably in such quantities that the fuel, on the one hand, and the oxygen, on the other hand, are present in the combustion chamber in stoichiometric proportions for a complete conversion of the fuel into carbon dioxide and water. In the case of pure oxygen being used as combustion gas, it is then the case that only carbon dioxide and water form as products of the combustion in the combustion chamber, such that the exhaust gas of the combustion engine also comprises only carbon dioxide and water. Operation of the combustion engine with other, non-stoichiometric combustion gas/fuel ratios is however also possible.

A fuel is to be understood to mean a substance or a substance mixture which can be converted, in particular burned, in the combustion chamber of the combustion engine with oxygen.

The fuel synthesis device is in particular configured for synthesizing an organic fuel from hydrogen and carbon dioxide. Here, an organic fuel is to be understood to mean a substance which has at least one compound comprising carbon, wherein the at least one compound comprising carbon has in particular a molecule with at least one C—H bond. The organic fuel may in particular be a hydrocarbon. It is however possible for the organic fuel to have—with regard to a molecule thereof—not only carbon and hydrogen but also oxygen. The organic fuel may thus in particular also be an alcohol, an ether, an ester, an aldehyde, a ketone, an organic acid or a mixture thereof.

The fuel synthesis device is particularly preferably configured to synthesize methane as fuel. The fuel synthesis device is thus particularly preferably designed as a methane synthesis device, also referred to as methanation device or methanizer.

The fuel formed in the fuel synthesis device may in particular be stored in a fuel storage device and/or fed into a fuel network, in particular an interconnected fuel network. In particular, methane produced by means of the fuel synthesis device can be fed into an interconnected natural gas network. It is however also possible for the methane to be compressed and stored, in particular as compressed natural gas (CNG), or to be liquefied and stored, in particular as liquefied natural gas (LNG). It is also possible for the methane formed in the fuel synthesis device to be converted—either still in the fuel synthesis device or else in at least one process step downstream thereof—into another chemical substance, in particular into methanol or polyoxymethylene dimethyl ether (OME).

In one refinement of the invention, provision is made for the combustion engine to be connected in terms of flow to the fuel synthesis device such that carbon dioxide formed in the combustion engine can be fed as starting product to the fuel synthesis device. In this way, the combustion engine interacts even more closely with the other components of the energy-converting device, specifically not only with the electrolysis device but also with the fuel synthesis device, giving rise to particularly pronounced synergistic effects. In particular, the carbon dioxide formed in the combustion engine can be utilized—preferably completely—in the fuel synthesis device and converted into the fuel, such that the combustion engine can ultimately be operated in a manner entirely free from pollutant emissions. Here, nitrogen oxides as pollutant emissions are eliminated in the case of pure oxygen from the electrolysis device being used as combustion gas, wherein the climate-relevant carbon dioxide formed by the combustion engine is not released into the surroundings but rather is fed as starting product to the fuel synthesis device and is converted there into the fuel. The nitrogen-free operation of the combustion engine furthermore permits particularly easy separation of the carbon dioxide from the exhaust gas of the combustion engine.

It is preferably also possible for carbon dioxide from other sources to be fed to the fuel synthesis device, in particular because the combustion engine is possibly operated not frequently enough, or not for a long enough period of time, to provide a quantity of carbon dioxide that is adequate for the operation of the fuel synthesis device. This is the case in particular if overcapacities of energy are regularly taken from the electricity network and used for the operation of the electrolysis device—wherein this provides negative control energy —, wherein the combustion engine is operated only temporarily and, in relation to the electrolysis device, rather briefly for providing positive control energy and/or heat—in particular for the fuel synthesis device.

The combustion engine preferably has a separation device for separating—in particular pure—carbon dioxide from the exhaust gas of the combustion engine. The separation device is in particular configured to separate water encompassed by the exhaust gas from the carbon dioxide that is likewise encompassed by the exhaust gas, such that in particular water-free, that is to say dry, preferably pure carbon dioxide can be fed to the fuel synthesis device.

The combustion engine is preferably connected in terms of flow to the electrolysis device such that water formed in the combustion engine can be fed as starting product to the electrolysis device. In this way, the interaction of the combustion engine with the further components of the energy-converting device is additionally improved, yielding further synergistic effects. In particular, the water separated off in the separation device can be fed as starting product to the electrolysis device. In this way, the substances formed by the combustion engine and encompassed by the exhaust gas thereof, specifically carbon dioxide and water, can be utilized completely in the energy-converting device.

The fuel synthesis device is preferably connected in terms of flow to the electrolysis device such that water formed in the fuel synthesis device can be fed as starting product to the electrolysis device. It is preferably specifically also the case that water is formed as a byproduct during the synthesis of the fuel from hydrogen and carbon dioxide. Said water can then advantageously be utilized in turn in the electrolysis device and split to form hydrogen and oxygen.

In one refinement of the invention, provision is made for the combustion engine to be configured to be operated, at least in the continuous operation mode, with the fuel synthesized in the fuel synthesis device. This yields further interaction of the combustion engine with the other components of the energy-converting device, and the synergistic effects are further increased. In particular if the combustion engine is operated only temporarily and briefly in relation to the electrolysis device and the fuel synthesis device, no additional fuel supply for the combustion engine is required, and the latter can in fact be operated entirely with the fuel produced in the fuel synthesis device.

The combustion engine is particularly preferably designed as a gas engine and is in particular configured to be operated with methane, in particular with methane produced in the fuel synthesis device designed as methane synthesis device, as fuel.

The combustion engine is connected in terms of flow to the fuel synthesis device such that fuel synthesized in the fuel synthesis device can be fed to the combustion engine as fuel for the combustion in at least one combustion chamber of the combustion engine.

Alternatively or in addition, the combustion engine is connected in terms of flow to the electrolysis device such that hydrogen produced in the electrolysis device can be fed to the combustion engine for combustion in the at least one combustion chamber of the combustion engine. Here, the hydrogen may be fed as the sole fuel, or else—particularly preferably—in addition to a further fuel, in particular in addition to the fuel synthesized in the fuel synthesis device, to the combustion in the combustion chamber of the combustion engine and thus assist the operation of the combustion engine.

The energy-converting device preferably has at least one store device for at least one substance produced or converted in the energy-converting device. A store device of said type is preferably provided in or along a flow connection between different components of the energy-converting device, and/or a store device of said type is provided in the region of an interface between surroundings of the energy-converting device and the energy-converting device. A store device of said type contributes in particular to a situation in which the various components of the energy-converting device can be operated temporally independently of one another, because a substance presently being consumed or produced does not have to be produced or consumed at the same moment, but rather can be temporarily stored.

The energy-converting device particularly preferably has an oxygen store device which is configured for storing, in particular temporarily storing, oxygen produced in the electrolysis device. Said oxygen store device is preferably provided in or along the flow connection between the electrolysis device and the combustion engine. The combustion engine can then in particular be operated with oxygen produced in the electrolysis device even when the electrolysis device is not active, wherein the combustion engine can be supplied with oxygen from the oxygen store device.

Alternatively or in addition, the energy-converting device preferably has a fuel store device which is configured to store, in particular temporarily store, the fuel synthesized in the fuel synthesis device. The fuel store device is preferably designed as a gas store.

The combustion engine is preferably connected in terms of flow to the fuel store device such that fuel from the fuel store device can be fed to the combustion engine in order to operate the combustion engine. The combustion engine can thus be operated with the fuel from the fuel synthesis device even when the latter is presently not active. Alternatively or in addition to a fuel store device, it is also possible for the energy-converting device and in particular the fuel synthesis device, on the one hand, and/or the combustion engine, on the other hand, to be connected in terms of flow to a fuel network, in particular a combustion gas network, particular preferably an interconnected natural gas network. In this case, the fuel network, in particular the interconnected natural gas network, may be used as a store device, in particular as a temporary store, with large capacity.

Alternatively or in addition, the energy-converting device preferably has a carbon dioxide store device. This is preferably arranged in or along the flow connection between the combustion engine, on the one hand, and the fuel synthesis device, on the other hand. The carbon dioxide store device is in particular configured to store, in particular temporarily store, carbon dioxide produced in the combustion engine. In this way, it is possible for carbon dioxide formed in the combustion engine to be fed to the fuel synthesis device even when the combustion engine is presently not active.

Alternatively or in addition, the energy-converting device preferably has a hydrogen store device. This is preferably arranged in or along the flow connection between the electrolysis device, on the one hand, and the fuel synthesis device, on the other hand, and/or in or along the flow connection between the electrolysis device, on the one hand, and the combustion engine, on the other hand. The hydrogen store device is in particular configured to store, in particular temporarily store, hydrogen produced in the electrolysis device. In this way, it is possible for hydrogen formed in the electrolysis device to be fed to the fuel synthesis device and/or to the combustion engine even when the electrolysis device is presently not active.

Alternatively or in addition, the energy-converting device preferably has a hydrogen store device which is designed to store, in particular temporarily store, water formed in the combustion engine and/or in the fuel synthesis device.

The water store device is preferably arranged in or along the flow connection between the combustion engine and the electrolysis device. In this way, water formed in the combustion engine can be fed to the electrolysis device even when said combustion engine is presently not active.

Alternatively or in addition, a water store device is preferably arranged in or along the flow connection between the fuel synthesis device and the electrolysis device. This may be the same water store device that is arranged in or along the flow connection between the combustion engine and the electrolysis device; it may however also be a separate, sole or additional water store device.

In one refinement of the invention, provision is made whereby the combustion engine has an exhaust-gas recirculation device which is configured to retain carbon-dioxide-containing and water-containing exhaust gas, formed in a previous combustion, in a combustion chamber of the combustion engine, or to recirculate said exhaust gas into the combustion chamber, for a subsequent combustion. Here, a previous combustion is to be understood to mean a combustion event temporally preceding the subsequent combustion, wherein a subsequent combustion is to be understood to mean a combustion event which temporally follows the previous combustion. The exhaust-gas recirculation device may, in a manner known per se, be designed as an internal exhaust-gas recirculation means or as an external exhaust-gas recirculation means. Such possibilities for exhaust-gas recirculation are known per se, such that these will not be discussed in any more detail. The high flame speed that arises in the case of the combustion of the fuel in the combustion chamber of the combustion engine with in particular pure oxygen as combustion gas can be alleviated, and in particular reduced to a level suitable for the operation of the combustion engine, through the recirculation of CO₂-containing and water-containing exhaust gas into the combustion chamber. Here, in particular in the case of pure oxygen being used as combustion gas, high exhaust-gas recirculation rates are necessary in order that the combustion in the combustion chamber takes place with a flame speed suitable for the operation of the combustion engine.

In one refinement of the invention, provision is made whereby the combustion engine is operatively connected in terms of drive to an electric machine, wherein the electric machine is electrically connectable to the electricity network. In this way, the combustion engine can in particular be utilized to provide positive control energy for the electricity network, for example if a deficiency of regenerative energy arises, in particular in calm periods in the case of wind power, and at night or in the presence of heavy cloud cover in the case of use of photovoltaics.

The combustion engine is particularly preferably designed as a combined heat and power plant or part of a combined heat and power plant. It is possible here for the combustion engine to be operated with electricity-based or heat-based control. In particular, the combustion engine may also be used to provide heat for the operation of the fuel synthesis device.

In one refinement of the invention, provision is made whereby the combustion engine is configured to be operated with ambient air as combustion gas in a starting operation mode. This is expedient in particular upon a commencement of operation of the combustion engine because, during the starting or run-up of said combustion engine, exhaust gas is not yet available in quantities sufficient for exhaust-gas recirculation, such that it would not be possible for the flame speed in the combustion chamber during the operation of the combustion engine with pure or concentrated oxygen as combustion gas to be lowered to a sufficient extent. The combustion engine is then preferably configured to switch from the starting operation mode into the continuous operation mode as soon as sufficient exhaust-gas recirculation is available for operation with pure or highly concentrated oxygen as combustion gas.

The combustion engine particularly preferably has a first valve device, by means of which a charging path of the combustion engine can be shut off with respect to surroundings of the combustion engine in a first functional position of the first valve device, wherein ambient air from the surroundings of the combustion engine can be fed to the charging path in a second functional position of the first valve device.

It is preferable if oxygen from the electrolysis device can be fed to the charging path of the combustion engine in the first functional position of the first valve device, and—in addition or alternatively—ambient air can be fed to said charging path in the second functional position of the first valve device.

The first functional position of the first valve device is assigned to the continuous operation mode, wherein the second functional position of the first valve device is assigned to the starting operation mode. A switch can thus be made between the continuous operation mode, on the one hand, and the starting operation mode, on the other hand, in particular by means of a switchover of the first valve device between the first functional position and the second functional position. In particular, by means of the first valve device, the combustion engine can, in the continuous operation mode, be isolated from the ambient air, such that said combustion engine can be operated exclusively with the oxygen produced in the electrolysis device as combustion gas.

The first valve device is preferably arranged in the charging path of the combustion engine and configured to, in the first functional position, produce a fluidic connection between the charging path and the flow connection of the combustion engine and the electrolysis device and shut off a fluidic connection between the charging path and an intake path for ambient air, wherein said first valve device, in the second functional position, opens up the fluidic connection between the charging path and the intake path for ambient air and instead shuts off the fluidic connection between the charging path and the flow connection to the electrolysis device.

It is however also possible for the first valve device to be provided independently of the flow connection between the electrolysis device and the charging path or the combustion chamber of the combustion engine, and to merely be configured to open up or shut off the fluidic connection of the charging path to the surroundings of the combustion engine in accordance with demand. In this case, in the second functional position of the first valve device, the combustion chamber can be fed not only with ambient air but also with oxygen from the electrolysis device, such that the combustion in the combustion chamber is performed not with pure oxygen, but rather with ambient air enriched with oxygen, that is to say with oxygen which is more highly concentrated in relation to ambient air.

The first valve device is at any rate preferably designed such that, in the first functional position of the first valve device, which corresponds to the continuous operation mode of the combustion engine, the flow connection of the charging path to the surroundings of the combustion engine can be shut off, such that pure oxygen from the electrolysis device can be fed to the combustion chamber.

The combustion engine preferably has a second valve device in an exhaust-gas path, by means of which second valve device, in a first functional position of the second valve device, a fluidic connection between the exhaust-gas path and surroundings of the combustion engine can be shut off, wherein, in a second functional position of the second valve device, the fluidic connection between the exhaust-gas path and the surroundings can be opened up. In this case, too, the first functional position of the second valve device is assigned to the continuous operation mode, wherein the second functional position of the second valve device is assigned to the starting operation mode. In the starting operation mode, owing to the use of ambient air as combustion gas, it is for example also the case that nitrogen oxides form, which cannot be used in the fuel synthesis device and which are rather released into the surroundings. By contrast, in the continuous operation mode, it is preferable for all of the exhaust gas of the combustion engine—with the latter being isolated from the surroundings—to be fed via the separation device on the one hand to the fuel synthesis device—specifically the carbon dioxide—and on the other hand to the electrolysis device—specifically the water.

The object is also achieved through the creation of an electricity network, which has at least one regenerative energy source, preferably a multiplicity of regenerative energy sources, and at least one energy-converting device according to any of the exemplary embodiments described above, wherein the at least one regenerative energy source and the energy-converting device are electrically connected to one another by means of electrical lines of the electricity network. Here, the electricity network is configured to feed at least preferably electrical power from the regenerative energy source to the electrolysis device of the energy-converting device. Here, it is possible in particular for overcapacity of electrical energy from the electricity network to be fed to the electrolysis device, such that the electrolysis device is used for providing negative control energy. At the same time, an electric machine that is operatively connected in terms of drive to the combustion engine is preferably electrically connected to the electricity network, wherein the combustion engine is configured or used to provide positive control energy for the electricity network. The combustion engine may however alternatively also be operated with heat-based control.

The electricity network is in particular associated with the advantages that have already been discussed in conjunction with the energy-converting device.

The object is also achieved through the creation of a method for operating an energy-converting device, in particular an energy-converting device according to any of the exemplary embodiments described above, wherein the energy-converting device has an electrolysis device which is connectable to an electricity network and which is configured to split water into hydrogen and oxygen by means of electrical power taken from the electricity network, wherein the energy-converting device furthermore has a fuel synthesis device which is configured to synthesize a fuel from hydrogen and carbon dioxide, wherein the energy-converting device furthermore has a combustion engine, which is in particular configured to be operated with oxygen, in particular with pure oxygen, or at least oxygen which is more highly concentrated in relation to ambient air of the combustion engine, as combustion gas, wherein hydrogen produced in the electrolysis device is fed as starting product to the fuel synthesis device, wherein oxygen produced in the electrolysis device is fed as combustion gas to the combustion engine, and wherein the combustion engine is operated in a continuous operation mode with the oxygen produced in the electrolysis device as combustion gas. The method is in particular associated with the advantages that have already been discussed in conjunction with the energy-converting device.

In one refinement of the invention, provision is made whereby carbon dioxide produced in the combustion engine is fed as starting product to the fuel synthesis device.

In one refinement of the invention, provision is made whereby the combustion engine is operated with a combustion gas/fuel ratio of 1, and consequently with stoichiometric combustion. In this case, in the case of operation with pure oxygen, only carbon dioxide and water form as combustion products in the combustion engine. Operation of the combustion engine with other, non-stoichiometric combustion gas/fuel ratios is however also possible.

The combustion engine is, at least in the continuous operation mode, operated preferably with fuel produced in the fuel synthesis device.

The combustion engine is preferably designed as a reciprocating-piston engine. It is preferably used in a static situation, for example for static energy supply in an emergency power operation, continuous load operation or peak load operation context, wherein, in this case, the combustion engine preferably drives a generator. A static implementation of the combustion engine for driving auxiliary assemblies, for example fire extinguishing pumps on drilling platforms, is also possible. Use of the combustion engine in the field of the delivery of fossil resources and in particular fuels, for example oil and/or gas, is furthermore possible.

The energy-converting device proposed here and/or the electricity network are suitable in particular for use in an infrastructure of a port, in particular of a seaport, very particularly of a port with a facility for loading and/or unloading tanker ships with chemical substances, in particular CNG, LNG, methanol, polyoxymethylene dimethyl ether or the like. Here, fuel formed in the fuel synthesis device can in particular be fed to such ships and/or used for some other use in the infrastructure, in particular also additionally or alternatively stored in a fuel network. Electrical energy and/or heat provided by the combustion engine may likewise be utilized in the infrastructure of the port, in particular for the operation and/or heating of buildings or infrastructure devices, such as for example cranes.

The descriptions of the energy-converting device, of the electricity network and of the method are to be understood as being complementary to one another. Features of the energy-converting device and/or of the electricity network that have been discussed explicitly or implicitly in conjunction with the method are preferably, individually or in combination with one another, features of a preferred exemplary embodiment of the energy-converting device and/or of the electricity network. Method steps that have been described explicitly or implicitly in conjunction with the energy-converting device and/or with the electricity network are preferably, individually or in combination with one another, steps of a preferred embodiment of the method. Said method is preferably distinguished by at least one method step which is a consequence of at least one feature of an exemplary embodiment according to the invention, or preferred exemplary embodiment, of the energy-converting device and/or of the electricity network. The energy-converting device and/or the electricity network are/is preferably distinguished by at least one feature which is a consequence of at least one step of an embodiment according to the invention, or preferred embodiment, of the method.

The invention will be discussed in more detail below on the basis of the drawing. Here, the single FIGURE is a schematic illustration of an exemplary embodiment of an electricity network with an energy-converting device, and an embodiment of a method for operating the energy-converting device.

The single FIGURE is a schematic illustration of an exemplary embodiment of an electricity network 1 with an exemplary embodiment of an energy-converting device 3, and is also a schematic illustration of an embodiment of a method for operating the energy-converting device 3.

The energy-converting device 3 is configured for converting electrical energy into chemical energy, wherein said energy-converting device has an electrolysis device 5 which is connected to the electricity network 1, wherein the electrolysis device 5 is configured to take electrical power Pₑₗ from the electricity network 1 and to split water (H₂O) into hydrogen (H₂) and oxygen (O₂) by means of said electrical power. The energy-converting device 3 furthermore has a fuel synthesis device 7, which is connected in terms of flow to the electrolysis device 5 such that hydrogen produced in the electrolysis device 5 can be fed as starting product to the fuel synthesis device 7, wherein the fuel synthesis device is configured to synthesize a fuel from hydrogen and carbon dioxide (CO₂). The fuel synthesis device 7 is in this case designed in particular as a methane synthesis device or methanizer and configured to synthesize methane (CH₄) from hydrogen and carbon dioxide.

The energy-converting device 3 furthermore has a combustion engine 9, which is connected in terms of flow to the electrolysis device 5 such that oxygen produced in the electrolysis device 5 can be fed to the combustion engine 9. Here, the combustion engine 9 is configured to be operated in a continuous operation mode with the oxygen produced in the electrolysis device 5 as combustion gas.

The combustion engine 9 is furthermore preferably connected in terms of flow to the fuel synthesis device 7 such that carbon dioxide formed in the combustion engine 9 can be fed as starting product to the fuel synthesis device 7. During a combustion in a combustion chamber 11 of the combustion engine 9, carbon-dioxide-containing exhaust gas forms, wherein, in the case of the energy-converting device 3 proposed here, the carbon dioxide is not released into the surroundings but rather is fed to the fuel synthesis device 7 as starting product for the production of the fuel, in this case in particular for the synthesis of methane.

For this purpose, the combustion engine 9 preferably has a separation device 13 which is configured to separate carbon dioxide, as far as possible in pure form, and preferably 100%, out of the exhaust gas of the combustion engine 9, wherein the pure carbon dioxide can then be fed from the separation device 13 via a suitable fluidic connection to the fuel synthesis device 7.

During the combustion in the combustion chamber 11, water also forms, which can preferably likewise be separated off in the separation device 13, wherein said water—as is schematically illustrated in the FIGURE—is in turn fed as starting product to the electrolysis device 5.

Water also forms as a byproduct in the fuel synthesis device 7, which water is preferably likewise fed as starting product to the electrolysis device 5.

If the combustion engine 9 is operated with pure oxygen as combustion gas in stoichiometric operation, only carbon dioxide and water form as products of the combustion in the combustion chamber 11, which carbon dioxide and water can be separated from one another in the separation device 13 and fed as separate substance streams to the fuel synthesis device 7, on the one hand, and to the electrolysis device 5, on the other hand. In this case, no combustion products of the combustion engine 9 are released into the surroundings, such that the combustion engine 9 can be operated in a manner free from pollutant emissions and even altogether free from emissions. Owing to the operation of the combustion engine 9 with pure oxygen from the electrolysis device 5, it is in particular the case that no nitrogen oxides form.

The combustion engine 9 is preferably designed to be operated, at least in the continuous operation mode, with the fuel synthesized in the fuel synthesis device 7, in this case in particular with methane. In this respect, the combustion engine 9 is preferably connected in terms of flow to the fuel synthesis device 7 such that fuel synthesized in the fuel synthesis device 7 can be fed to the combustion engine 9 for combustion in the combustion chamber 11. The combustion engine 9 is designed in particular as a gas engine. It is however not necessary for the combustion engine 9 and the fuel synthesis device 7 to be directly connected to one another in terms of flow. It is possible for a fuel store device to be arranged between the combustion engine 9 and the fuel synthesis device 7. It is also possible for the fuel synthesis device 7, on the one hand, and combustion engine 9, on the other hand, to each be connected to a fuel network, for example an interconnected natural gas network.

It is however also possible for the combustion engine 9 to draw a fuel, in particular a combustion gas, preferably methane, from a fuel source that is independent of the fuel synthesis device 7, wherein the fuel synthesized in the fuel synthesis device 7 is used in some other way, in particular stored. For example, it is possible for the combustion engine 9 to be connected to the interconnected natural gas network, wherein the fuel produced in the fuel synthesis device 7 is not fed into the interconnected natural gas network but is rather stored in a fuel store device in order to subsequently be fed for some other use.

It is also possible for the combustion engine 9 to be connected in terms of flow to the electrolysis device 5 such that hydrogen produced in the electrolysis device 5 can be fed to the combustion engine 9 for combustion in the combustion chamber 11. This may be performed in particular in addition or alternatively to the use of a further fuel, in particular of the fuel produced in the fuel synthesis device 7. The hydrogen may thus be used in particular as sole fuel, but also for assisting a combustion in the combustion chamber 11—in particular with a small fraction—in addition to a further fuel.

The combustion engine 9 has an exhaust-gas recirculation device 15 which is configured to retain carbon-dioxide-containing and water-containing exhaust gas, formed in the combustion chamber 11 in a previous combustion, in the combustion chamber 11, or to recirculate said exhaust gas into the combustion chamber 11, for a subsequent combustion. For this purpose, exhaust gas may in particular be branched off upstream of the separation device 13 or in the separation device 13 and fed to a charging path 17 of the combustion engine. In this respect, the FIGURE schematically illustrates an external exhaust-gas recirculation arrangement. It is however also possible for the combustion engine 9 to be configured to realize internal exhaust-gas recirculation. A combustion of a fuel with pure oxygen, in particular a combustion of methane with pure oxygen, requires exhaust-gas recirculation and in particular high exhaust-gas recirculation rates in order to lower the flame speed in the combustion chamber 11 to a level suitable for the operation of the combustion engine 9.

It is possible for the exhaust-gas recirculation device 15 to have an adjusting device (not illustrated here) for adjusting an exhaust-gas recirculation rate, for example an exhaust-gas recirculation flap or the like.

The combustion engine 9 is preferably operatively connected in terms of drive to an electric machine 19, wherein the electric machine 19 is electrically connected to the electricity network 1. The electric machine 19 is preferably in particular operated as a generator and driven by the combustion engine 9 such that it can generate electrical power and feed this into the electricity network 1. Thus, the combustion engine 9 is in particular configured to provide positive control energy for the electricity network 1.

The combustion engine 9 may in particular be part of a combined heat and power plant or constitute a combined heat and power plant, wherein it is preferably operated with electricity-based or heat-based control. In particular, it is possible for the combustion engine 9 to be operated at least intermittently in order to produce and provide heat for the fuel synthesis device 7.

The combustion engine 9 is preferably configured to be operated with ambient air as combustion gas in a starting operation mode. For this purpose, the combustion engine 9 preferably has a first valve device 21, by means of which, in one embodiment, the charging path 17 is, in a first functional position of the first valve device 21, separated from surroundings of the combustion engine 9 and connected in terms of flow to the electrolysis device 5, such that oxygen from the electrolysis device 5 can be fed to the charging path 17. In a second functional position of the first valve device 21, the charging path 17 is preferably connected in terms of flow to the surroundings of the combustion engine 9, such that ambient air can be fed as combustion gas to the charging path 17.

It is important that the first valve device 21 is designed such that, in the first functional position of the first valve device 21, which corresponds to the continuous operation mode of the combustion engine 9, the flow connection of the charging path 17 to the surroundings of the combustion engine 9 can be shut off such that pure oxygen from the electrolysis device 5 can be fed to the combustion chamber 11.

It is possible for the first valve device 21—as illustrated here—to be provided independently of the fluidic connection between the electrolysis device 5 and the combustion chamber 11 of the combustion engine 9, and to merely be configured to open up and shut off the fluidic connection of the charging path 17 to the surroundings of the combustion engine 9 in accordance with demand. In this case, in the second functional position of the first valve device 21, the combustion chamber 11 can be fed not only with ambient air but also with oxygen from the electrolysis device 5, such that the combustion in the combustion chamber 11 is performed not with pure oxygen, but rather with ambient air enriched with oxygen.

The second functional position of the first valve device 21 corresponds to the starting operation mode of the combustion engine 9.

The first valve device 21 is preferably arranged in the charging path 17.

Here, the combustion engine 9 furthermore has a second valve device 23, by means of which an exhaust-gas path 25, in a first functional position of the second valve device 23, can be separated from the surroundings of the combustion engine 9 and, in a second functional position of the second valve device 23, can be connected in terms of flow to the surroundings. It is also the case here that the second functional position of the second valve device 23 corresponds to the starting operation mode of the combustion engine 9, in which—owing to the nitrogen fed to the combustion chamber 11 by way of the ambient air—nitrogen oxides also form in the combustion chamber 11 during the combustion, such that, in any case, the exhaust gas that is formed cannot be completely utilized within the energy-converting device 3, such that at least a part of the exhaust gas, preferably all of the exhaust gas of the combustion engine 9 in the starting operation mode, can be emitted into the surroundings of said combustion engine.

The first functional position of the second valve device 23 corresponds to the continuous operation mode of the combustion engine 1. In this case, the exhaust gas of the combustion engine 9, which comprises only carbon dioxide and water, is utilized entirely within the energy-converting device 3, on the one hand as starting product for the fuel synthesis device 7 and the electrolysis device 5 and on the other hand for reducing the flame speed in the combustion engine 9 via the exhaust-gas recirculation device 15, such that no fraction of the exhaust gas is then released into the surroundings of the combustion engine 9.

The electricity network 1 preferably has at least one regenerative energy source 27, in particular a photovoltaic installation, a wind turbine, a hydroelectric power plant or the like, wherein the regenerative energy source 27 and the energy-converting device 3 are electrically connected to one another by means of electrical lines 29 of the electricity network 1. The electricity network 1 preferably has a multiplicity of regenerative energy sources 27, in particular also regenerative energy sources of different type, for example photovoltaic installations and wind turbines, hydroelectric power plants and/or the like.

The electricity network 1 is configured to—at least preferably—feed electrical power from the regenerative energy source 27 to the electrolysis device 5. In particular, the electrolysis device 5 is preferably utilized, in the presence of an overcapacity of—in particular regeneratively produced—electrical energy in the electricity network 1, for providing negative control energy, that is to say for absorbing electrical power from the electricity network 1.

The combustion engine 9 is preferably utilized to provide positive control energy for the electricity network 1, that is to say to feed electrical power into the electricity network 1, if an undercapacity of electrical energy is present in the electricity network 1, that is to say a present consumption of electrical power threatens to overshoot a present generation of electrical power in the electricity network 1.

Provision is particularly preferably made whereby the electrolysis device 5 and the combustion engine 9 can be activated and deactivated—automatically or manually—by an operator of the electricity network 1 in accordance with demand.

The energy-converting device 3 preferably has at least one store device, selected in particular from a group comprising a hydrogen store device, an oxygen store device, a fuel store device, a carbon dioxide store device and a water store device. Such a store device may serve in particular as a buffer or temporary store, such that the various substance flows in the energy-converting device 3 can be maintained independently of the present operation of the individual components, that is to say of the electrolysis device 5, of the fuel synthesis device 7 and of the combustion engine 9. The individual components can thus in particular be operated even when other components are presently not active, because they can thus store their products in correspondingly suitable store devices and/or draw their starting products from correspondingly suitable store devices.

As already stated, the combustion engine 9 is preferably operated with a stoichiometric ratio of oxygen to fuel, in particular methane, such that the exhaust gas of the combustion engine 9 has exclusively carbon dioxide and water. Stoichiometric operation furthermore has the advantage that the exhaust gas of the combustion engine 9 is free from oxygen. This is rather fully converted in the combustion chamber 11. Operation of the combustion engine 9 with other, non-stoichiometric combustion gas/fuel ratios is however also possible.

With the energy-converting device 3 proposed here, the electricity network 1 and the method for the operation thereof, a means is created for efficiently operating the individual components of an energy-converting device 3, in particular an electrolysis device 5, a fuel synthesis device 7 and a combustion engine 9, integrally with one another, utilizing a multiplicity of synergistic effects, and in the process considerably reducing, preferably eliminating, pollutant emissions.

1-10. (canceled)

11. An energy-converting device for converting electrical energy into chemical energy, comprising:
an electrolysis device connectable to an electricity network and configured to split water into hydrogen and oxygen by electrical power from the electricity network;
a fuel synthesis device connected in terms of flow to the electrolysis device so that hydrogen produced in the electrolysis device is feedable as a starting product to the fuel synthesis device, wherein the fuel synthesis device is configured to synthesize a fuel from hydrogen and carbon dioxide; and
a combustion engine connected in terms of flow to the electrolysis device so that oxygen produced in the electrolysis device is feedable to the combustion engine, wherein
the combustion engine is configured to be operated in a continuous operation mode with the oxygen produced in the electrolysis device as combustion gas.

12. The energy-converting device according to claim 11, wherein the combustion engine is connected in terms of flow to the fuel synthesis device so that carbon dioxide formed in the combustion engine is feedable as a starting product to the fuel synthesis device.

13. The energy-converting device according to claim 11, wherein
a) the combustion engine is configured to be operated, at least in the continuous operation mode, with the fuel synthesized in the fuel synthesis device, and/or
b) the combustion engine is connected in terms of flow to the electrolysis device such that hydrogen produced in the electrolysis device is fed to the combustion engine for combustion in a combustion chamber of the combustion engine.

14. The energy-converting device according to claim 11, wherein the combustion engine has an exhaust-gas recirculation device configured to retain carbon-dioxide-containing and water-containing exhaust gas, formed in a previous combustion, in a combustion chamber of the combustion engine, or to recirculate said exhaust gas into the combustion chamber for a subsequent combustion.

15. The energy-converting device according to claim 11, further comprising an electric machine electrically connectable to the electricity network, wherein the combustion engine is operatively connected in terms of drive to the electric machine.

16. The energy-converting device according to claim 11, wherein the combustion engine is configured to be operated with ambient air as combustion gas in a starting operation mode, wherein the combustion engine has a first valve device with a first functional position that shuts off a charging path of the combustion engine with respect to surroundings of the combustion engine, and a second functional position in which ambient air from the surroundings of the combustion engine is fed to the charging path.

17. An electricity network, comprising: at least one regenerative energy source; an energy-converting device according to claim 11; and electrical lines that electrically connect the energy-converting device and the at least one regenerative energy source to one another, wherein the electricity network is configured to feed electrical power from the at least one regenerative energy source to the electrolysis device of the energy-converting device.

18. A method for operating an energy-converting device having
an electrolysis device connected to an electricity network and configured to split water into hydrogen and oxygen by electrical power from the electricity network,
a fuel synthesis device configured to synthesize a fuel from hydrogen and carbon dioxide, and
a combustion engine, the method comprising steps of:
feeding hydrogen produced in the electrolysis device as a starting product to the fuel synthesis device;
feeding oxygen produced in the electrolysis device to the combustion engine; and
operating the combustion engine in a continuous operation mode with the oxygen produced in the electrolysis device as combustion gas.

19. The method according to claim 18, including feeding carbon dioxide produced in the combustion engine as starting product to the fuel synthesis device.

20. The method according to claim 18, including operating the combustion engine with stoichiometric combustion.
